(19) United States
(12) Patent Application Publication
(10) Pub. No.: US 2004/0052086 A1
(43) Pub. Date: Mar. 18, 2004

(54) Vehicle brake light system and method

(76) Inventor: Menachem Hadar, Yavne (IL)

Correspondence Address: Abelman Frayne & Schwab, 150 East 42nd Street, New York, NY, 10017-5612, US

(21) Appl. No.: 10/398,503

(22) PCT Filed: Sep. 25, 2001
(86) PCT No.: PCT/IL01/00899

(30) Foreign Application Priority Data
Oct. 3, 2000 (IL) 138838

(51) Int. Cl. B60Q 1/26

(52) U.S. Cl. 362/541

(57) ABSTRACT

A brake light system and a brake light illumination method including a braking action responsive switch, at least one braking indicator light and braking indicator light actuation circuitry responsive to the braking action responsive switch for initially illuminating the at least one braking indicator light to a relatively high level of illumination and thereafter reducing illumination of the at least one braking indicator light to a relatively low level of illumination.

### FIELD OF THE INVENTION

The present invention relates to motor vehicle safety generally and more particularly to brake light actuation systems and methods.

### BACKGROUND OF THE INVENTION

Brake lights have long been an essential safety feature of motor vehicles, indicating to a following driver that a vehicle in front of him is decelerating. In recent years brake lighting systems have been proposed which included a plurality of sequentially lighted brake lights and brake lights whose intensity indicates the extent of braking.

### SUMMARY OF THE INVENTION

The present invention seeks to provide a new brake light system, which, it is believed, enhances the alert level to a following driver.

There is thus provided in accordance with a preferred embodiment of the present invention a brake light system including a braking action responsive switch, at least one braking indicator light and braking indicator light actuation circuitry responsive to the braking action responsive switch for initially illuminating the at least one braking indicator light to a relatively high level of illumination and thereafter reducing illumination of the at least one braking indicator light to a relatively low level of illumination.

There is also provided in accordance with a preferred embodiment of the present invention a brake light illumination method including:

responsive to braking action, initially illuminating at least one braking indicator light to a relatively high level of illumination; and thereafter

reducing illumination of the at least one braking indicator light to a relatively low level of illumination.

Preferably, the relatively high level of illumination is higher than a nominal level of illumination employed in most conventional brake light systems. Preferably the relatively low level of illumination is identical to the nominal level of illumination.

In accordance with one embodiment of the present invention, the braking indicator light actuation circuitry is operative to illuminate the at least one braking indicator light at the relatively high level of illumination for a first time duration and to illuminate the at least one braking indicator light at the relatively low level of illumination for a second duration.

### BRIEF DESCRIPTION OF THE DRAWINGS

The present invention will be understood and appreciated more fully from the following detailed description, taken in conjunction with the drawings in which:

FIGS. 1A and 1B are simplified illustrations of two operational states in the operation of the system and method of the present invention, an initial braking-high level brake light illumination and a continued braking-low level brake light illumination;

FIG. 2 is a diagram illustrating the variation in brake light illumination intensity as a function of time;

FIG. 3 is a simplified block diagram illustration of the system of the present invention; and

FIG. 4 is a schematic illustration of actuation circuitry employed in accordance with a preferred embodiment of the present invention.

### DETAILED DESCRIPTION OF A PREFERRED EMBODIMENT

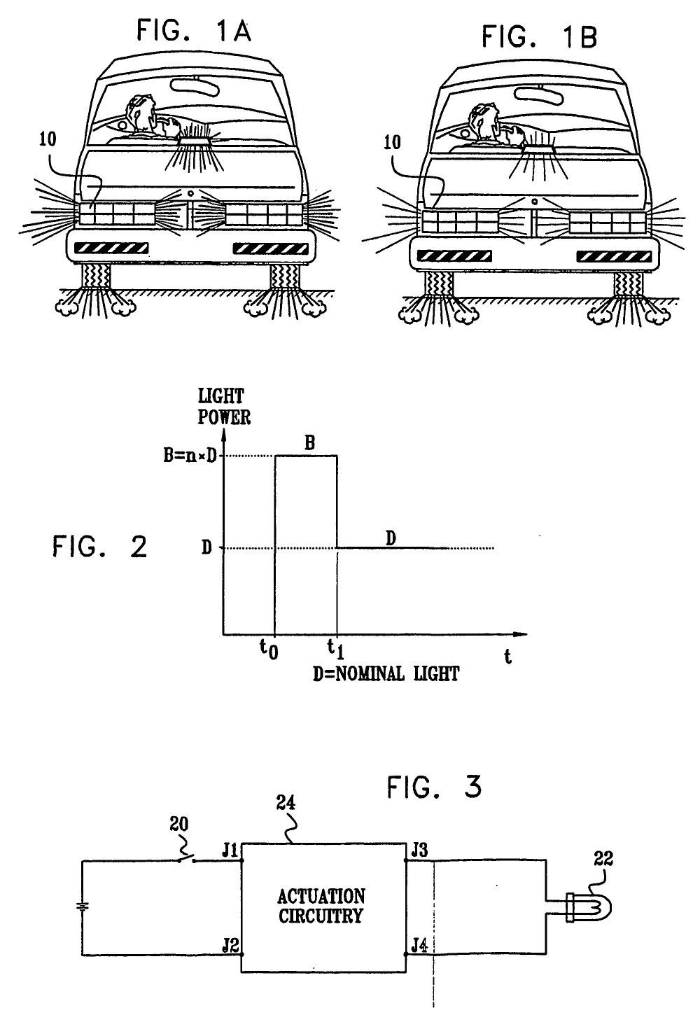

Reference is now made to FIGS. 1A, 1B and 2 which are simplified illustrations of two operational states in the operation of the system and method of the present invention, initial braking-high level brake light illumination and continued braking-low level brake light illumination.

In accordance with a preferred embodiment of the present invention, when braking action is not taking place, brake lights 10 are not illuminated. Upon the onset of braking action, (tₒ) as illustrated in FIG. 1A, the brake lights 10 are illuminated to a relatively high level of illumination designated “B” in FIG. 2, preferably, significantly higher than the conventional level of illumination of brake lights in conventional vehicles.

As seen in FIG. 1B, preferably after a predetermined time duration, typically approximately one second, the level of illumination of the brake lights is reduced, preferably to the conventional nominal level designated “D” in FIG. 2 (t₁). Preferably the relatively high level of illumination is approximately twice the electrical power level of the relatively low level of illumination (n˜2).

It is to be appreciated that the functionality described hereinabove with respect to FIGS. 1A, 1B & 2 provides increased awareness of braking on the part of a following driver, since that driver senses multiple transitions between intensities at multiple levels rather than just a single off-on transition, as in the prior art.

Reference is now made to FIG. 3, which is a functional block diagram of the system and method of a preferred embodiment of the present invention. As seen in FIG. 3, a braking action responsive switch 20, preferably associated with a vehicle braking system, operates at least one braking indicator light 22, such as light 10 in FIGS. 1A & 1B, via braking indicator light actuation circuitry 24.

Circuitry 24 is responsive to the braking action responsive switch 20 for initially illuminating the at least one braking indicator light to a relatively high level of illumination and thereafter reducing illumination of the at least one braking indicator light 22 to a relatively low level of illumination.

Preferably, the relatively high level of illumination is at least twice as high as a nominal level of illumination employed in most conventional brake light systems.

In accordance with one embodiment of the present invention, the braking indicator light actuation circuitry 24 is operative to illuminate the at least one braking indicator light 22 at the relatively high level of illumination for a first time duration and to illuminate the at least one braking indicator light 22 thereafter as long as the brakes are engaged.

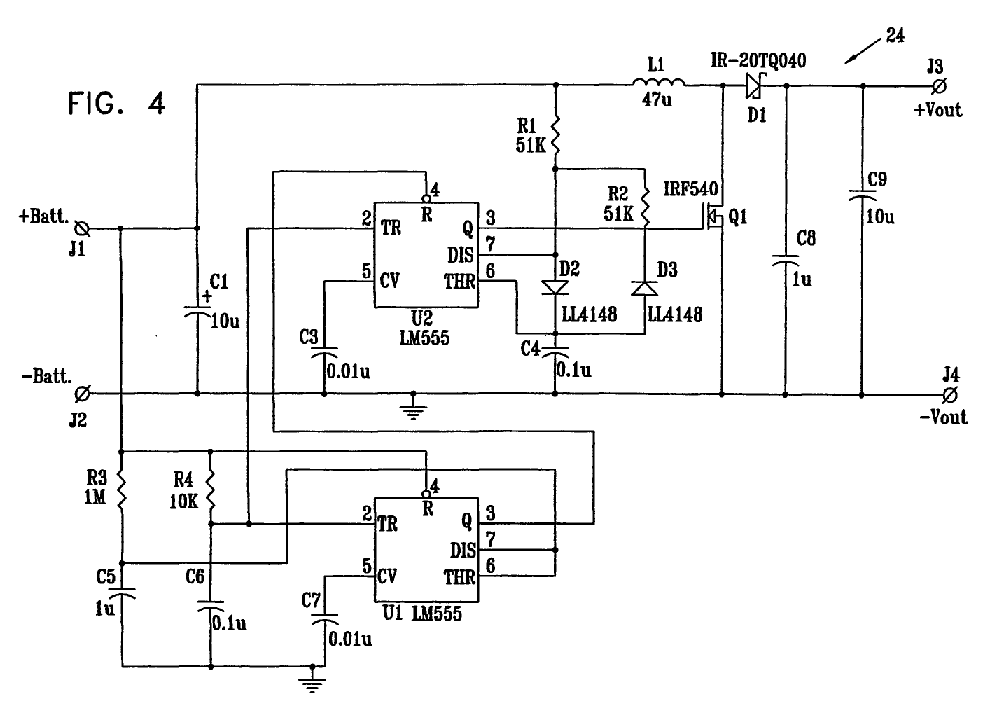

Reference is now made to FIG. 4, which is a schematic illustration of actuation circuitry, such as circuitry 24 (FIG. 3) employed in accordance with a preferred embodiment of the present invention. For the sake of conciseness, the circuit parameters, which are clearly shown in FIG. 4 are not here repeated in prose. The designations J1-J4, which appear in FIG. 3, also appear in FIG. 4 to facilitate understanding of the relationship between FIGS. 3 and 4.

It is appreciated that the present invention may be carried out by circuitry other than that shown in FIGS. 3 and 4. For example, a pair of bimetallic switches may be employed to cause brake light activation to be initially at a relatively high level and thereafter at a relatively low level.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A brake light system including a braking action responsive switch, at least one braking indicator light and braking indicator light actuation circuitry responsive to the braking action responsive switch for initially illuminating the at least one braking indicator light to a relatively high level of illumination and thereafter reducing illumination of the at least one braking indicator light to a relatively low level of illumination.

2. A brake light system according to claim 1 and wherein said actuation circuitry provides a first voltage to said at least one braking indicator light for producing said relatively low level of illumination and provides a second voltage, higher than said first voltage, to said at least one braking indicator light for producing said relatively high level of illumination.

3. A brake light system according to claim 1 or claim 2 and wherein said actuation circuitry produces said relatively high level of illumination for a predetermined time duration, and thereafter reduces the level of illumination.

4. A brake light system according to any of claims 1-3 and wherein said predetermined time duration is approximately one second.

5. A brake light system according to any of claims 1-4 and wherein the electrical power level of said relatively high level of illumination is approximately twice the electrical power level of the relatively low level of illumination.

6. A brake light illumination method including:
responsive to braking action, initially illuminating at least one braking indicator light to a relatively high level of illumination; and thereafter
reducing illumination of the at least one braking indicator light to a relatively low level of illumination.

7. A brake light illumination method according to claim 6 and wherein actuation circuitry provides a first voltage to said at least one braking indicator light for producing said relatively low level of illumination and provides a second voltage, higher than said first voltage, to said at least one braking indicator light for producing said relatively high level of illumination.

8. A brake light illumination method according to claim 6 or claim 7 and wherein said relatively high level of illumination is produced for a predetermined time duration, and is thereafter reduced.

9. A brake light illumination method according to any of claims 6-8 and wherein said predetermined time duration is approximately one second.

10. A brake light illumination method according to any of claims 6-9 and wherein the electrical power level of said relatively high level of illumination is approximately twice the electrical power level of the relatively low level of illumination.
